(19) United States
(12) Patent Application Publication
(10) Pub. No.: US 2025/0249659 A1
(43) Pub. Date: Aug. 7, 2025

(54) COMPOSITE MATERIAL STRUCTURE AND MANUFACTURING METHOD THEREOF

(71) Applicants: Han-Ching Huang, Taipei City (TW); Jung-Chin Wu, Taipei City (TW)

(72) Inventors: Han-Ching Huang, Taipei City (TW); Jung-Chin Wu, Taipei City (TW)

(73) Assignee: COMPAL ELECTRONICS, INC., Taipei City (TW)

(21) Appl. No.: 18/429,442

(22) Filed: Feb. 1, 2024

(51) Int. Cl. B32B 15/14; B32B 3/26; B32B 7/12; B32B 38/06

(52) U.S. Cl. CPC B32B 15/14; B32B 3/266; B32B 7/12; B32B 38/06; B32B 2255/06; B32B 2255/20; B32B 2260/021; B32B 2260/046; B32B 2305/08; B32B 2307/7376

(57) ABSTRACT

A composite material structure, including an outer layer, an inner layer, a middle layer, a protective layer, and an anodized layer, is provided. The outer layer includes a first metallic material and has an outer surface and an inner surface opposite to each other. The inner layer includes a fiber composite material composed of a fiber material and a resin material, a second metallic material, or a metal fiber composite material composed of the fiber composite material and the second metallic material. The middle layer includes an adhesive material and is disposed between the outer layer and the inner layer. The protective layer includes an anodization-resistant material and is disposed on the inner layer. The anodized layer is located on the outer surface and is an oxide film composed of the first metallic material. A manufacturing method thereof is also provided.

### BACKGROUND

### Technical Field

The disclosure relates to a composite material structure and a manufacturing method thereof.

### Description of Related Art

In order to meet the requirements of product aesthetics and application, an anodized layer is often formed on a metal outer layer. However, the processing environment of anodizing is relatively harsh. For example, extreme conditions such as strong acid, strong alkali, and high temperature may be encountered during the process. Therefore, a film layer with low tolerance in a workpiece being processed is easily damaged.

### SUMMARY

The disclosure provides a composite material structure and a manufacturing method thereof, which can reduce the probability of being damaged during an anodizing process.

A composite material structure of the disclosure includes an outer layer, an inner layer, a middle layer, a protective layer, and an anodized layer. The outer layer includes a first metallic material and has an outer surface and an inner surface opposite to each other. The inner layer includes a fiber composite material composed of a fiber material and a resin material, a second metallic material, or a metal fiber composite material composed of the fiber composite material and the second metallic material. The middle layer includes an adhesive material and is disposed between the outer layer and the inner layer. The protective layer includes an anodization-resistant material and is disposed on the inner layer. The anodized layer is located on the outer surface of the outer layer. The anodized layer is an oxide film composed of the first metallic material.

A manufacturing method of a composite material structure of the disclosure at least includes the following steps. A protective layer is formed on an inner layer. The protective layer includes an anodization-resistant material. A bonding process is executed to bond an outer layer, the protective layer, and the inner layer by a middle layer. The middle layer includes an adhesive material, and the outer layer includes a first metallic material. The inner layer includes a fiber composite material composed of a fiber material and a resin material, a second metallic material, or a metal fiber composite material composed of the fiber composite material and the second metallic material. An anodizing process is executed to form an anodized layer on an outer surface of the outer layer.

Based on the above, the protective layer in the composite material structure of the disclosure can reliably protect the inner layer with poor material tolerance and reduce an area thereof exposed to a harsh environment during the anodizing process. In this way, the probability of being damaged during the anodizing process can be reduced.

In order for the features and advantages of the disclosure to be more comprehensible, the following specific embodiments are described in detail in conjunction with the drawings.

### BRIEF DESCRIPTION OF THE DRAWINGS

FIG. 1A is a schematic cross-sectional view of a composite material structure according to an embodiment of the disclosure.

FIG. 1B is a schematic top view of the composite material structure of FIG. 1A.

FIG. 2A to FIG. 2H are schematic cross-sectional views of a manufacturing method of a composite material structure according to some embodiments of the disclosure.

FIG. 2I to FIG. 2J are schematic disassembly views of the composite material structure of FIG. 2H.

FIG. 2K is a schematic top view of the composite material structure of FIG. 2D.

FIG. 2L is a schematic cross-sectional view of the composite material structure of FIG. 2D according to an alternative embodiment.

FIG. 3A to FIG. 3E are schematic cross-sectional views of a manufacturing method of a composite material structure according to some embodiments of the disclosure.

FIG. 3F to FIG. 3G are schematic disassembly views of the composite material structure of FIG. 3E.

### DESCRIPTION OF THE EMBODIMENTS

The disclosure will be described more fully with reference to the drawings of the embodiments. However, the disclosure may also be embodied in various forms and should not be limited to the embodiments described herein. The thicknesses, sizes, or dimensions of layers or regions in the drawings are exaggerated for clarity. The same or similar reference numerals indicate the same or similar elements and will not be repeated one by one in the following paragraphs.

In the following, reference numerals will be attached to describe the preferred embodiments of the disclosure in detail and to illustrate with the drawings. Where possible, the drawings may omit unnecessary components for the sake of clarity.

Directional terms (for example, upper, lower, right, left, front, back, top, and bottom) used herein are used with reference to the drawings only and are not intended to imply absolute orientations.

Unless otherwise defined, all terms (including technical and scientific terms) used herein have the same meaning as commonly understood by one of ordinary skill in the art to which the disclosure belongs.

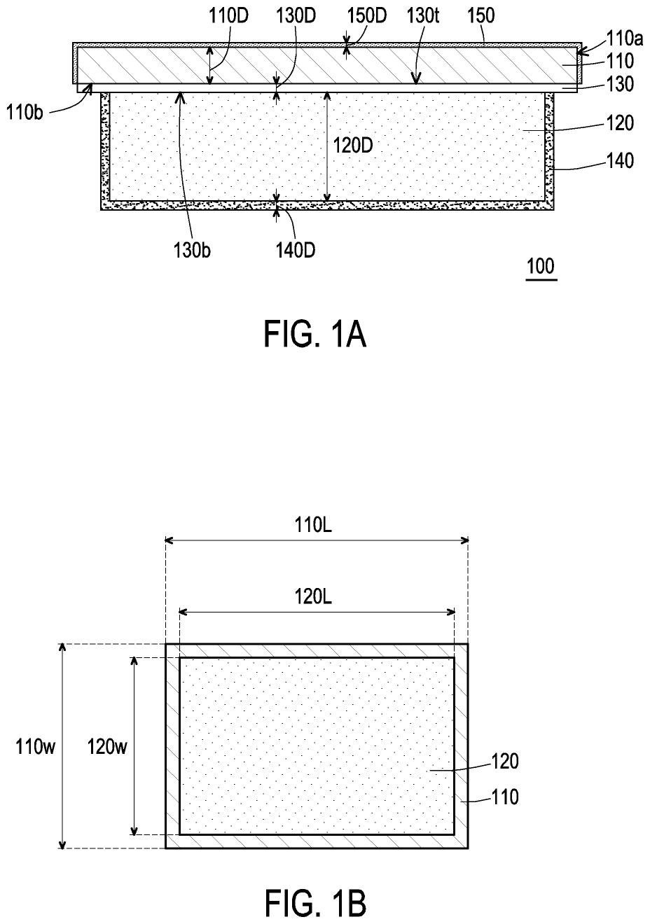

FIG. 1A is a schematic cross-sectional view of a composite material structure according to an embodiment of the disclosure. FIG. 1B is a schematic top view of the composite material structure of FIG. 1A, wherein FIG. 1B is a perspective drawing and omits a middle layer, a protective layer, and an anodized layer.

Please refer to FIG. 1A. In the embodiment, a composite material structure 100 includes an outer layer 110, an inner layer 120, and a middle layer 130. The outer layer 110 has an outer surface 110a and an inner surface 110b opposite to each other, the middle layer 130 is disposed between the outer layer 110 and the inner layer 120, and two opposite surfaces (for example, an upper surface 130t and a lower surface 130b) of the middle layer 130 are respectively in direct contact with the inner surface 110b of the outer layer 110 and the inner layer 120. In addition, the outer layer 110 includes at least one first metallic material, so that the composite material structure 100 may present a metallic appearance. The inner layer 120 includes a fiber composite material composed of a fiber material and a resin material, a second metallic material, or a metal fiber composite material composed of the fiber composite material and the second metallic material, and the middle layer 130 includes an adhesive material.

In addition, the composite material structure 100 further includes a protective layer 140 and an anodized layer 150, wherein the protective layer 140 includes an anodization-resistant material and is disposed on the inner layer 120, the anodized layer 150 is located on the outer surface 110a of the outer layer 110, and the anodized layer 150 is an oxide film composed of the first metallic material of the outer layer 110. Specifically, the anodized layer 150 is an oxide film layer formed on a surface of a metal substrate (for example, the outer layer 110) by adopting an anodizing process, wherein the so-called anodizing process includes processes such as thermal degreasing, alkali washing, pickling, neutralization, chemical polishing, anode, dyeing, sealing, hot water washing, and high temperature sealing. The pH range of a process bath solution may be between 3 and 11, and the temperature may reach as high as 104 degrees, but the disclosure is not limited thereto, and the specific conditions of the anodizing process may be determined according to actual design requirements. Accordingly, the protective layer 140 in the composite material structure 100 of the embodiment can reliably protect the inner layer 120 with poor material tolerance and reduce an area thereof exposed to a harsh environment during the anodizing process. In this way, the possibility of being damaged during the anodizing process can be reduced. An exemplary manufacturing process of the composite material structure will be further described below.

In some embodiments, the inner layer 120, the middle layer 130, and the protective layer 140 are disposed on a side of the outer layer 110 opposite to the inner surface 110b of the outer surface 110a, but the disclosure is not limited thereto.

In the embodiment, a first thickness 110D of the outer layer 110 is different from a second thickness 120D of the inner layer 120. Accordingly, the composite material structure 100 of the embodiment can effectively reduce the use of materials and simplify the processes by the design of the asymmetric structure between the outer layer 110 and the inner layer 120, and can effectively reduce the difference in thermal expansion coefficients between the inner layer 120 and the outer layer 110 by the selection of the material of the inner layer 120. Therefore, the composite material structure 100 of the embodiment can effectively balance thermal stress while reducing manufacturing costs.

Here, since the thermal expansion coefficient of the resin material in the inner layer 120 is greater than the thermal expansion coefficient of the first metallic material, and the thermal expansion coefficient of the fiber material (for example, a high-rigidity material) is between the thermal expansion coefficient of the resin material and the thermal expansion coefficient of the first metallic material, when the material of the inner layer 120 is selected as the combination of the resin material and the fiber material, the thermal expansion and contraction of the resin material can be suppressed by the fiber material to reduce the difference in thermal expansion coefficients with the first metallic material. Therefore, residual stress can be reduced to effectively improve warping deformation.

In some embodiments, the first thickness 110D is less than the second thickness 120D, which can better balance the thermal stress. For example, the range of the first thickness 110D may be greater than or equal to 0.1 millimeter (mm) and less than or equal to 1 mm (for example, 0.1 mm, 0.3 mm, 0.5 mm, 0.7 mm, 1 mm, or any value within the above range of 0.1 mm to 1 mm), and the range of the second thickness 120D may be greater than or equal to 0.2 mm and less than or equal to 5 mm (for example, 0.2 mm, 3 mm, 4 mm, 5 mm, or any value within the above range of greater than or equal to 0.2 mm to 5 mm), but the disclosure is not limited thereto.

In some embodiments, a third thickness 130D of the middle layer 130 is between 0.01 mm and 0.3 mm (for example, 0.01 mm, 0.05 mm, 0.1 mm, 0.3 mm, or any value within the above range of 0.01 mm to 0.3 mm), but the disclosure is not limited thereto.

In some embodiments, a fourth thickness 140D of the protective layer 140 is between 5 microns (um) and 1 mm (for example, 5 um, 10 um, 100 um, 500 um, 1 mm, or any value within the above range of 5 um to 1 mm), and a fifth thickness 150D of the anodized layer 150 is between 5 um and 20 um, but the disclosure is not limited thereto.

In some embodiments, the outer layer 110 has a first density and a first modulus, the inner layer 120 has a second density and a second modulus, the first density is different from the second density, and the first modulus is different from the second modulus, for example, the first density is greater than the second density, and the first modulus is greater than the second modulus, but the disclosure is not limited thereto. It should be noted that the density and the modulus vary depending on the selection of the metallic material, the fiber material, and the resin material, that is, the values of the density and the modulus may be inferred based on the required materials selected for the actual design.

Please refer to FIG. 1B. The outer layer 110 has a first length 110L and a first width 110w, and the inner layer 120 has a second length 120L and a second width 120w, wherein the first length 110L is greater than the second length 120L, and the first width 110w is greater than the second width 120w. In other words, the inner layer 120 is retracted in the contour of the outer layer 110. For example, a difference value between the first length 110L and the second length 120L is greater than 1 mm, and a difference value between the first width 110w and the second width 120w is greater than 1 mm. In this way, adverse effects caused by rebound and contraction of the protective layer 140 after being formed can be improved, but the disclosure is not limited thereto.

In some embodiments, the first metallic material in the outer layer 110 is different from the second metallic material in the inner layer 120. For example, the first metallic material in the outer layer 110 includes an aluminum alloy (Al), a titanium alloy (Ti), stainless steel (SUS), or other appropriate commercial metal sheet materials that may be anodized, and the second metallic material in the inner layer 120 includes a magnesium aluminum alloy (Mg—Al), a magnesium lithium alloy (Mg—Li), or other appropriate lightweight alloys. In addition, the fiber material of the inner layer 120 includes carbon fiber (may be any suitable carbon fiber), glass fiber, plant fiber, a combination thereof, or other appropriate continuous or discontinuous fiber materials. The resin material includes a thermoplastic resin and a thermosetting resin, wherein the thermoplastic resin includes polycarbonate (PC), polyethylene terephthalate (PET), polymethyl methacrylate (PMMA), polyethylene (PE), acrylonitrile butadiene styrene (ABS), polypropylene (PP), polystyrene (PS), polyamide (PA), and the thermosetting resin includes epoxy and phenol, but the disclosure is not limited thereto.

In some embodiments, when the inner layer 120 is made from a composite material such as lightweight alloy composed of aluminum alloy (30 wt %) and magnesium aluminum alloy (70 wt %), compared to aluminum alloy, it can show a similar anode appearance while reduce density and weight by 26.5%, such that more advantages are obtained, as shown in Table 1, but the disclosure is not limited thereto. The actual composition, type, and thickness or the like still need to be determined according to requirements of the actual design such as the appearance, weight, and rigidity or the like.

TABLE 1

| | composite material | |
|---|---|---|
| | composed of the aluminum | |
| | alloy and the magnesium | |
| | aluminum alloy | aluminum alloy |
| Thickness (mm) | 1.0 | 1.0 |
| Density (g/cm³) | 1.97 | 2.68 |
| Weight (g) | 152 | 206 |
| (335 × 230 mm) | | |
| anode appearance | Yes | Yes |

In some embodiments, when only one fiber material is used in the inner layer 120, recycling can be easier, but the disclosure is not limited thereto.

In some embodiments, the adhesive material of the middle layer 130 includes an adhesive film selected from epoxy, polyether polyol, polyurethane (PU), or a combination thereof, but the disclosure is not limited thereto. The middle layer 130 may be any suitable thermally reactive adhesive material.

In some embodiments, the glass softening temperature of the middle layer 130 is between 65° C. and 180° C. (for example, 65° C., 80° C., 140° C., 180° C., or any value within the above range of 65° C. to 180° C.), so when a low-temperature hot pressing process is subsequently used, the middle layer 130 can be effectively softened, but the disclosure is not limited thereto.

In some embodiments, the glass softening temperature of the middle layer 130 is between 65° C. and 90° C., which can be closer to the low-temperature process, but the disclosure is not limited thereto.

In some embodiments, the anodization-resistant material includes polyurethane (PU), epoxy acrylate (EA), or a combination thereof, but the disclosure is not limited thereto.

A main manufacturing processes of the composite material structure according to some embodiments of the disclosure will be illustrated below with the drawings. It must be noted here that the reference numerals and some content of the above embodiment will continue to be used below, wherein the same or similar numerals are used to represent the same or similar elements, and the description of the same technical content is omitted. For the description of the omitted part, reference may be made to the above embodiment, which will not be repeated.

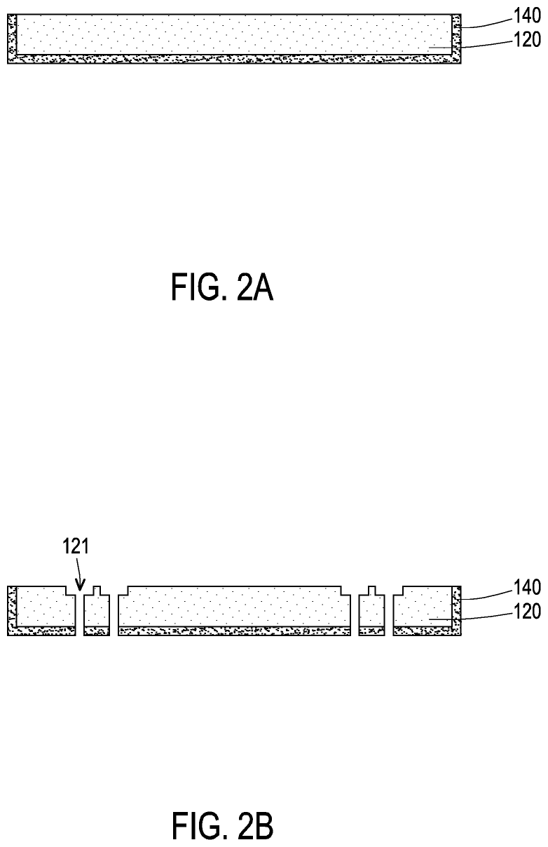

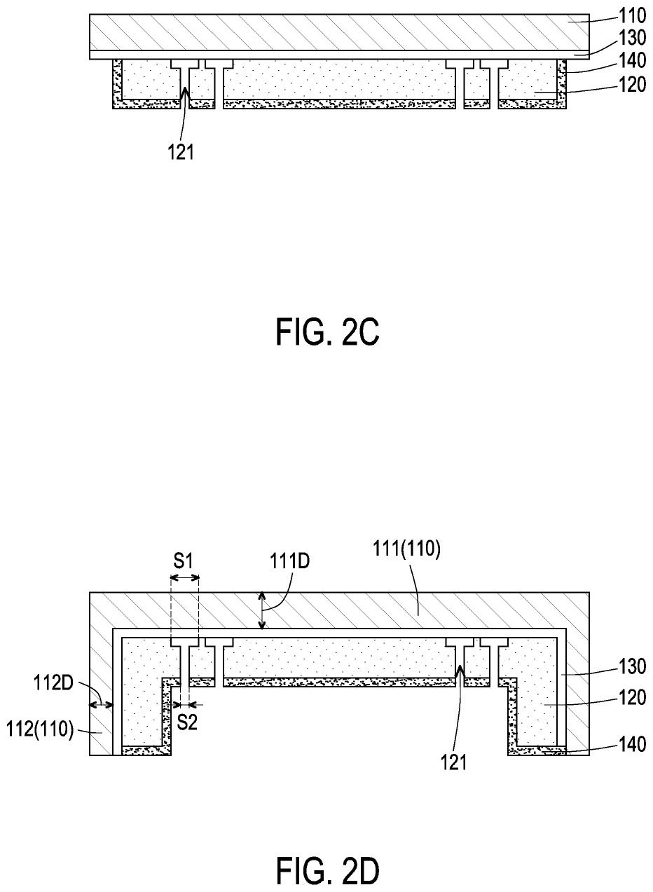

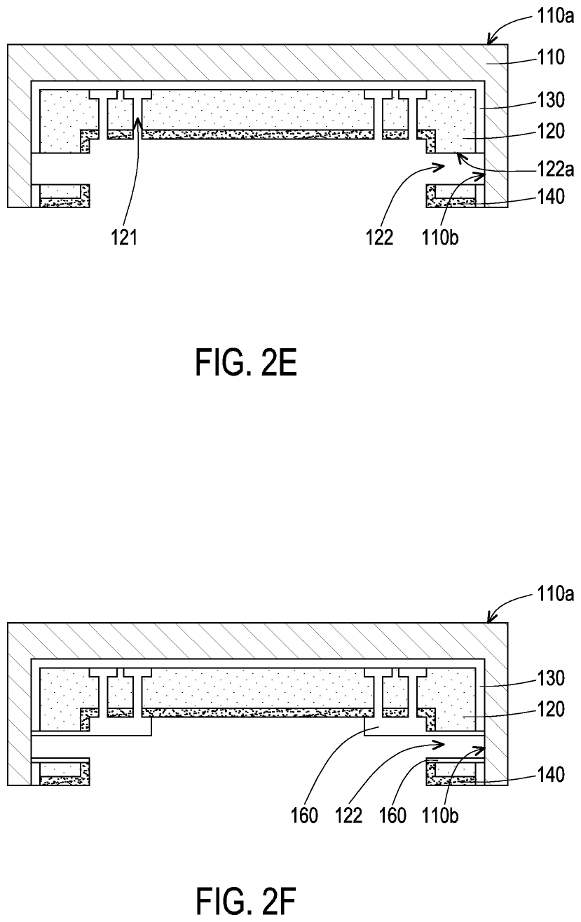

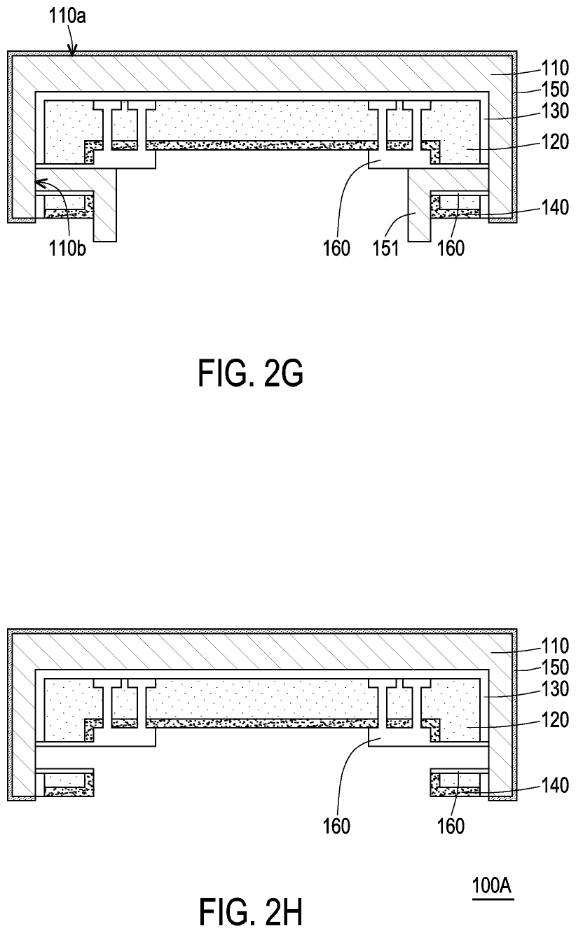

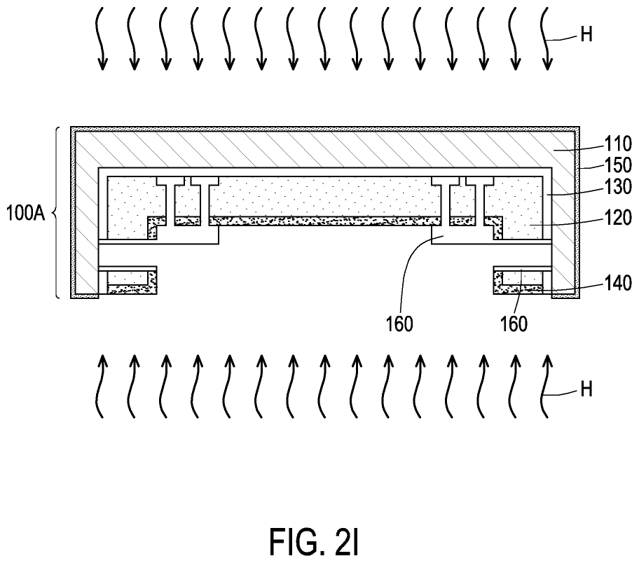

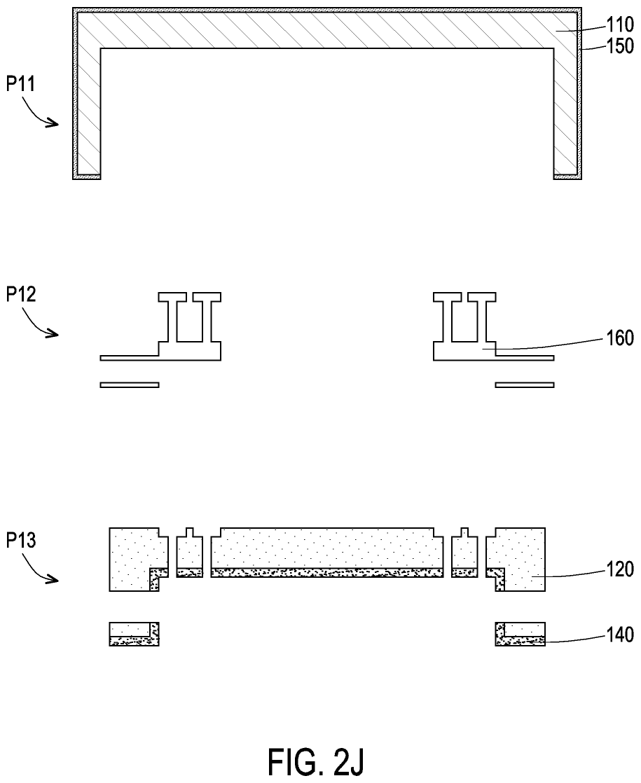

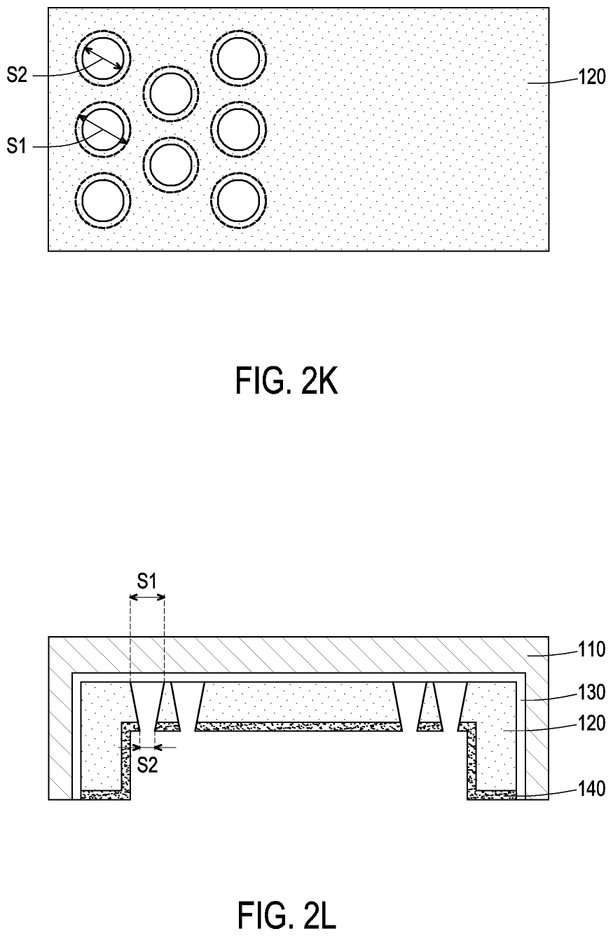

FIG. 2A to FIG. 2H are schematic cross-sectional views of a manufacturing method of a composite material structure according to some embodiments of the disclosure. FIG. 2I to FIG. 2J are schematic disassembly views of the composite material structure of FIG. 2H. FIG. 2K is a schematic top view of the composite material structure of FIG. 2D. For clarity of explanation, FIG. 2K only shows a reinforcing hole and a part of the inner layer around the reinforcing hole of FIG. 2D. FIG. 2L is a schematic cross-sectional view of the composite material structure of FIG. 2D according to an alternative embodiment.

Please refer to FIG. 2A. In an embodiment, the protective layer 140 is formed on the inner layer 120, wherein the protective layer 140 includes the anodization-resistant material, and the inner layer 120 includes the lightweight material. The anodization-resistant material and the lightweight material may be similar to the content described in FIG. 1A, which will not be repeated. In addition, the protective layer 140 is, for example, fittingly covered on the inner layer 120 through spray coating or the adhesive film.

Please refer to FIG. 2B. Optionally, if the rigidity of the structure in subsequent processes is to be improved, a reinforcing hole 121 may be formed in the inner layer 120. Furthermore, in the embodiment, the reinforcing hole 121 may penetrate the inner layer 120 and the protective layer 140 through mechanical processing, laser processing, or other appropriate removal processes. Here, the specific design of the reinforcing hole 121 will be further explained in FIG. 2D, FIG. 2K, and FIG. 2L.

Please refer to FIG. 2C. A bonding process is executed to bond the outer layer 110, the protective layer 140, and the inner layer 120 by the middle layer 130 (the outer layer 110 is located on a side of the middle layer 130, and the protective layer 140 and the inner layer 120 are located on the other opposite side of the middle layer 130), wherein the middle layer 130 includes the adhesive material, and the outer layer 110 includes the first metallic material. The adhesive material and the first metallic material may be similar to the content described in FIG. 1A, and in FIG. 2C (before a stamping forming process is executed), the size designs of the outer layer 110, the inner layer 120, the middle layer 130, and the protective layer 140 may also be similar to the content described in FIG. 1A and FIG. 1B, which will not be repeated.

In some embodiments, the bonding process is, for example, a low-temperature hot pressing bonding process, wherein the temperature is, for example, lower than 100° C., but the disclosure is not limited thereto.

Please refer to FIG. 2D. The stamping forming process is executed on the outer layer 110, the inner layer 120, the middle layer 130, and the protective layer 140 to form the required appearance of a product (for example, an electronic housing). For example, the outer layer 110, the inner layer 120, the middle layer 130, and the protective layer 140 may be bent downward to form an inverted U shape, wherein the outer layer 110 may form a top surface portion 111 and a side wall portion 112. In the embodiment, a sixth thickness 112D of the side wall portion 112 is less than a seventh thickness 111D of the top surface portion 111 (such as being equal to the first thickness 110D), but the disclosure is not limited thereto. Here, the stamping forming process may be cold stamping, hot stamping, or other appropriate stamping forming processes, which is not limited in the disclosure.

Further, please refer to FIG. 2D and FIG. 2K. The reinforcing hole 121 may have a non-uniform size design from the middle layer 130 to the protective layer 140 to better meet the fluidity requirement in a subsequent injection molding process. For example, the reinforcing hole 121 has a first size S1 and a second size S2. The first size S1 is an end size of the reinforcing hole 121 exposed to the middle layer 130 (the side close to the middle layer 130), and the second size S2 is an end size of the reinforcing hole 121 at the protective layer 140 (the side close to the protective layer 140), and the first size S1 is greater than the second size S2, wherein the second size S2 may be greater than 0.5 mm. In addition, in the embodiment, the reinforcing hole 121 may only have the first size S1 and the second size S2, but the disclosure is not limited thereto. As shown in FIG. 2L, the reinforcing hole 121 may be in a tapered shape to have a tapered size, that is, the size of the reinforcing hole 121 from the middle layer 130 to the protective layer 140 may continue to change in a shrinking manner.

Please refer to FIG. 2E. An anode hole 122 is formed in the inner layer 120, wherein the anode hole 122 penetrates the inner layer 120 and the middle layer 130 to expose a part of the outer layer 110 (for example, the inner surface 110b of the outer layer 110) to serve as a hanging point in the subsequent anodizing process. Here, the anode hole 122 may be formed through mechanical processing, laser processing, or other appropriate processes.

Please refer to FIG. 2F. The injection molding process is executed to form reinforcing layers 160 in the reinforcing hole 121 and the anode hole 122, wherein the reinforcing layer 160 may completely fill the reinforcing hole 121. At the same time, the reinforcing layer 160 may extend to a side wall 122a (as shown in FIG. 2E) of the anode hole 122, but not completely fill the anode hole 122, so that the inner surface 110 of a part of the outer layer 110 is exposed. In this way, the reinforcing layer 160 with a non-uniform size design (the minimum size is, for example, greater than 0.5 mm) may reinforce the issue of insufficient bonding strength of a male mold surface structure through an anchor bolt action, wherein the side where the protective layer 140 is located may be used as an injection entry point. In addition, based on the material properties of the reinforcing layer 160, the parts of the inner layer 120 exposed due to the formation of the reinforcing hole 121 and the anode hole 122 can be reliably protected to prevent the parts from suffering adverse effects such as corrosion during the subsequent anodizing process, but the disclosure is not limited thereto.

In the embodiment, the reinforcing layer 160 includes an injection molding material and is partially embedded in the inner layer 120 to be in direct contact with the middle layer 130, and a part of the reinforcing layer 160 is disposed in the anode hole 122, wherein the injection molding material includes polycarbonate (PC), polycarbonate/acrylonitrile butadiene styrene (PC/ABS), polypropylene (PP), nylon, polybutylene terephthalate (PBT), or a combination thereof, but the disclosure is not limited thereto. The injection molding material may be an injection material containing fibers added in various proportions.

Please refer to FIG. 2G. The anodizing process is executed to form the anodized layer 150 on the outer surface 110a of the outer layer 110, wherein the anodized layer 150 includes an oxidized material, and the oxidized material may be similar to the content described in FIG. 1A, which will not be repeated. In the embodiment, the anodizing process may include disposing a hanger 151 in the anode hole 122 such that the hanger 151 is in direct contact with the inner surface 110b of the outer layer 110, and disposing a component to be processed in an anodizing liquid such that the oxidized material is formed on the exposed outer surface 110a of the outer layer 110, but the disclosure is not limited thereto. It should be noted that the formation position of the anodized layer 150 shown in FIG. 2G is only exemplary. The formation position of the anodized layer 150, the anodizing liquid in the anodizing process, and other specific details may be determined according to actual design requirements, which is not limited in the disclosure.

Please refer to FIG. 2H. After the anodized layer 150 is formed, the hanger 151 is removed to obtain a composite material structure 100A. Accordingly, the protective layer 140 in the composite material structure 100A of the embodiment can reliably protect the inner layer 120 with poor material tolerance and reduce an exposed area thereof exposed to a harsh environment during the anodizing process. In this way, the possibility of being damaged during the anodizing process can be reduced. In addition, the design of the reinforcing layer 160 can further improve processability, and the design of the anode hole 122 can enable the anodizing process to proceed more smoothly, wherein the reinforcement layer 160 and the anode hole 122 are optional, that is, depending on the requirements, the reinforcement layer 160 and the anode hole 122 may be omitted or replaced by other appropriate structures or processes.

Please refer to FIG. 2I and FIG. 2J. When the middle layer 130 is the thermally reactive adhesive material (for example, the glass softening temperature is between 65° C. and 180° C.), a heating process may be executed, such as heating to above the reaction temperature of the middle layer 130, so that multiple portions of the composite material structure 100A are disassembled and separated through the middle layer 130 to achieve easy recycling. For example, a heat H may be applied to the used composite material structure 100A, so that the composite material structure 100A may be disassembled into a first portion P11 (including the outer layer 110 and the anodized layer 150), a second portion P12 (including the reinforcing layer 160), and the third portion P13 (including the inner layer 120 and the protective layer 140) through the middle layer 130, but the disclosure is not limited thereto.

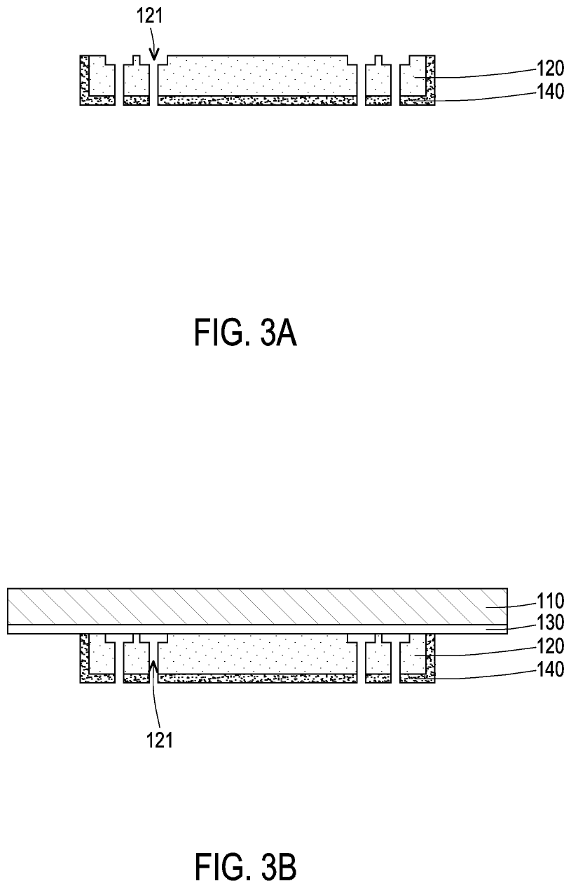

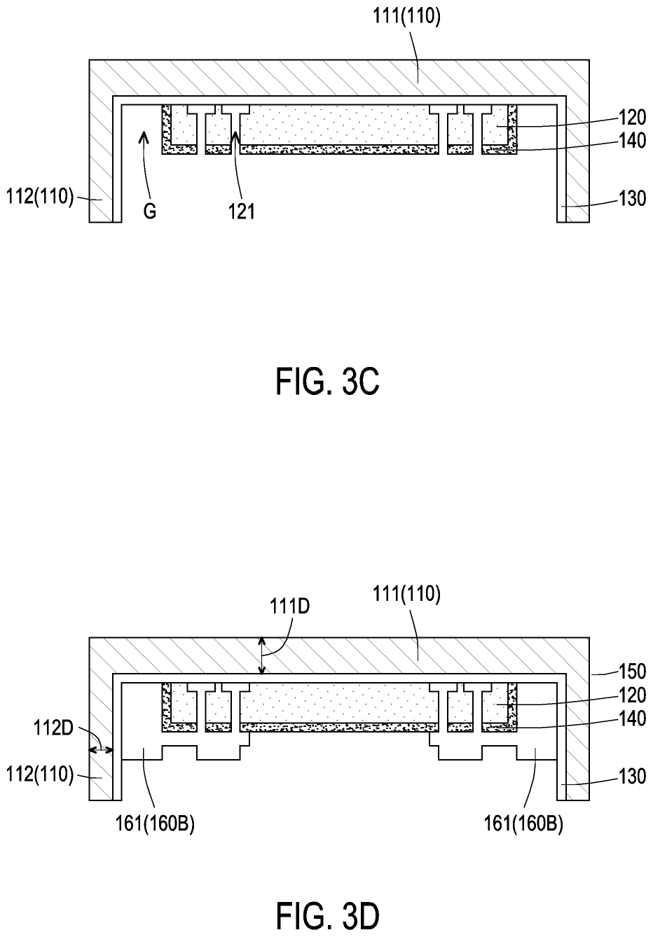

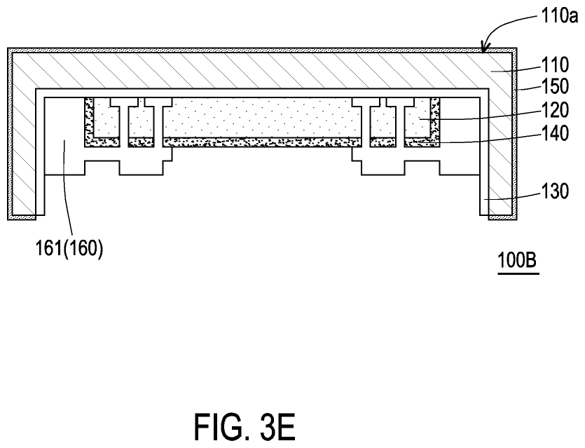

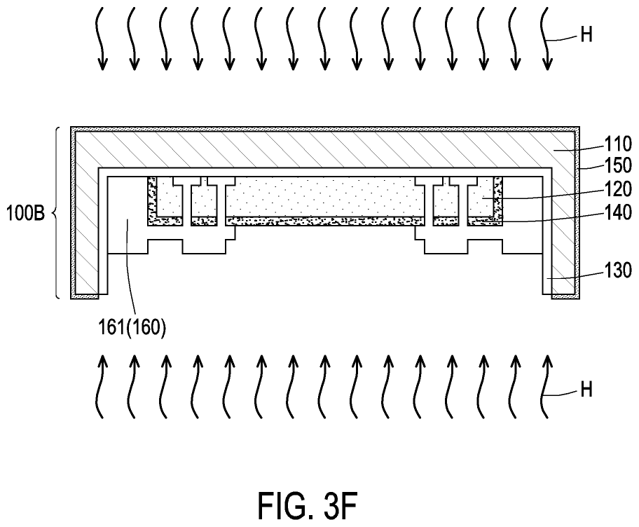

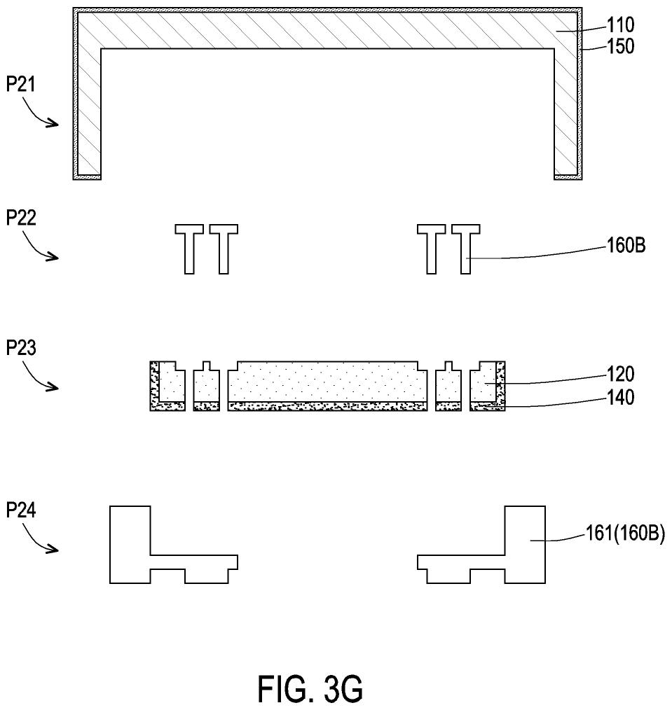

FIG. 3A to FIG. 3E are schematic cross-sectional views of a manufacturing method of a composite material structure according to some embodiments of the disclosure. FIG. 3F to FIG. 3G are schematic disassembly views of the composite material structure of FIG. 3E.

Please refer to FIG. 3A. The reinforcing hole 121 is formed in the inner layer 120 and the protective layer 140. The specific details may be similar to FIG. 2B, which will not be repeated.

Please refer to FIG. 3B and FIG. 3C. The bonding process is executed to bond the outer layer 110, the protective layer 140, and the inner layer 120 by the middle layer 130, and the stamping forming process is executed. The specific details may be similar to FIG. 2C and FIG. 2D, and the difference is that in this embodiment, the stamping forming process is only executed on the outer layer 110 and the middle layer 130, so that two sides of the inner layer 120 and the protective layer 140 form a gap G with the top surface portion 111 and the side wall portion 112 of the outer layer 110.

Please refer to FIG. 3D. The injection molding process is executed to form a reinforcing layer 160B in the reinforcing hole 121 and the gap G, wherein the reinforcing layer 160B includes a return portion 161 extending between the outer layer 110 and the protective layer 140. Here, the sixth thickness 112D of the side wall portion 112 is between 1 and 1.5 times the seventh thickness 111D of the top surface portion 111, but the disclosure is not limited thereto.

Please refer to FIG. 3E. The anodizing process is executed to form the anodized layer 150 on the outer surface 110a of the outer layer 110 to obtain a composite material structure 100B. The specific details may be similar to FIG. 2G and/or FIG. 2H, which will not be repeated. Accordingly, the protective layer 140 in the composite material structure 100B of the embodiment can reliably protect the inner layer 120 with poor material tolerance and reduce the exposed area thereof exposed to a harsh environment during the anodizing process. In this way, the possibility of being damage during the anodizing process can be reduced. In addition, the return portion 161 enables the thickening design of the side wall portion 112 of the outer layer 110 to have greater adjustment flexibility.

It should be noted that although not shown in the drawings, the composite material structure of the embodiment may also include the anode hole portion described in the above embodiments, and the anodizing process is performed through the anode hole portion, but the disclosure is not limited thereto. Also, the anode hole may be omitted and the anodizing process may be performed through other appropriate processing.

Please refer to FIG. 3F and FIG. 3G. When the middle layer 130 is the thermally reactive adhesive material (for example, the glass softening temperature is between 65° C. and 180° C.), the heating process may be executed, such as heating to above the reaction temperature of the middle layer 130, so that multiple portions of the composite material structure 100B are disassembled and separated through the middle layer 130 to achieve easy recycling. For example, the heat H may be applied to the used composite material structure 100B. In this way, the composite material structure 100B may be disassembled into a first portion P21 (including the outer layer 110 and the anodized layer 150), a second portion P22 (including a part of the reinforcing layer 160B), a third portion P23 (including the inner layer 120 and the protective layer 140), and a fourth portion P24 through the middle layer 130, but the disclosure is not limited thereto.

In summary, the protective layer in the composite material structure of the disclosure can reliably protect the inner layer with poor material tolerance and reduce the exposed area thereof exposed to a harsh environment during the anodizing process. In this way, the possibility of being damaged during the anodizing process can be reduced.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A composite material structure, comprising:
an outer layer, comprising a first metallic material, wherein the outer layer has an outer surface and an inner surface opposite to each other;
an inner layer, comprising a fiber composite material composed of a fiber material and a resin material, a second metallic material, or a metal fiber composite material composed of the fiber composite material and the second metallic material;
a middle layer, comprising an adhesive material and disposed between the outer layer and the inner layer;
a protective layer, comprising an anodization-resistant material and disposed on the inner layer; and
an anodized layer, located on the outer surface of the outer layer, wherein the anodized layer is an oxide film composed of the first metallic material.

2. The composite material structure according to claim 1, wherein the outer layer has a first thickness, the inner layer has a second thickness, and the first thickness is less than the second thickness.

3. The composite material structure according to claim 2, wherein a range of the first thickness is greater than or equal to 0.1 mm to less than or equal to 1 mm, and a range of the second thickness is greater than or equal to 0.2 mm to less than or equal to 5 mm.

4. The composite material structure according to claim 1, wherein a third thickness of the middle layer is between 0.01 mm and 0.3 mm, a fourth thickness of the protective layer is between 5 um and 1 mm, and a fifth thickness of the anodized layer is between 5 um and 20 um.

5. The composite material structure according to claim 1, wherein the outer layer has a first density, the inner layer has a second density, and the first density is greater than the second density.

6. The composite material structure according to claim 1, wherein the outer layer has a first length and a first width, the inner layer has a second length and a second width, the first length is greater than the second length, and the first width is greater than the second width.

7. The composite material structure according to claim 6, wherein a difference value between the first length and the second length is greater than 1 mm, and a difference value between the first width and the second width is greater than 1 mm.

8. The composite material structure according to claim 1, wherein the first metallic material comprises an aluminum alloy, a titanium alloy, stainless steel, or a combination thereof, the second metallic material comprises a magnesium-aluminum alloy, a magnesium-lithium alloy, or a combination thereof, the fiber material comprises carbon fiber, glass fiber, plant fiber, or a combination thereof, the resin material comprises polycarbonate, polyethylene terephthalate, polymethyl methacrylate, polyethylene, acrylonitrile butadiene styrene, polypropylene, polystyrene, polyamide, epoxy, or phenol, the adhesive material comprises an adhesive film selected from epoxy, polyether polyol, polyurethane, or a combination thereof, and the anodization-resistant material comprises polyurethane, epoxy acrylate, or a combination thereof.

9. The composite material structure according to claim 1, further comprising an anode hole penetrating a part of the inner layer and the middle layer to expose the part of the inner surface.

10. The composite material structure according to claim 9, further comprising a reinforcing layer comprising an injection molding material and partially embedded in the inner layer to be in direct contact with the middle layer.

11. The composite material structure according to claim 10, wherein a part of the reinforcing layer is disposed in the anode hole.

12. The composite material structure according to claim 10, wherein the injection molding material comprises polycarbonate, polycarbonate/acrylonitrile butadiene styrene, polypropylene, nylon, polybutylene terephthalate, or a combination thereof.

13. The composite material structure according to claim 10, wherein a size of a side of the reinforcing layer close to the middle layer is greater than a size of other side close to the protective layer.

14. The composite material structure according to claim 13, wherein the size of the side of the reinforcing layer close to the protective layer is greater than 0.5 mm.

15. The composite material structure according to claim 10, wherein the outer layer comprises a top surface portion and a side wall portion, the reinforcing layer comprises a return portion extending between the outer layer and the protective layer, and a sixth thickness of the side wall portion is between 1 and 1.5 times a seventh thickness of the top surface portion.

16. A manufacturing method of a composite material structure, comprising:
forming a protective layer on an inner layer, wherein the protective layer comprises an anodization-resistant material;
executing a bonding process to bond an outer layer, the protective layer, and the inner layer by a middle layer, wherein the middle layer comprises an adhesive material, the outer layer comprises a first metallic material, and the inner layer comprises a fiber composite material composed of a fiber material and a resin material, a second metallic material, or a metal fiber composite material composed of the fiber composite material and the second metallic material; and
executing an anodizing process to form an anodized layer on an outer surface of the outer layer.

17. The manufacturing method of the composite material structure according to claim 16, further comprising executing a stamping forming process on at least the outer layer and the middle layer after the bonding process and before the anodizing process.

18. The manufacturing method of the composite material structure according to claim 17, further comprising forming a reinforcing hole in the inner layer before the bonding process, and executing an injection molding process after the stamping forming process to form a reinforcing layer in the reinforcing hole.

19. The manufacturing method of the composite material structure according to claim 18, further comprising forming an anode hole in the inner layer after the stamping forming process and before the injection molding process, wherein the anode hole exposes a part of the outer layer, and the reinforcing layer is further formed in the anode hole after executing the injection molding process.

20. The manufacturing method of the composite material structure according to claim 16, wherein a glass softening temperature of the adhesive material is between 65° C. and 180° C.
